(19) United States
(12) Patent Application Publication
(10) Pub. No.: US 2007/0094402 A1
(43) Pub. Date: Apr. 26, 2007

(54) Method, process and system for sharing data in a heterogeneous storage network

(76) Inventors: Harold R. Stevenson, Holliston, MA (US); David A. Miranda, Miami, FL (US); William Yeager, Atlanta, GA (US)

Correspondence Address: MOSS & BARNETT P.A., 4800 Wells Fargo Center, 90 South Seventh Street, Minneapolis, MN, 55402-4129, US

(21) Appl. No.: 11/582,718

(22) Filed: Oct. 17, 2006

Related U.S. Application Data
(60) Provisional application No. 60/728,036, filed on Oct. 17, 2005.

(51) Int. Cl. G06F 15/16

(52) U.S. Cl. 709/229

(57) ABSTRACT

A method, process and system of controlling the transmission of data in a heterogeneous environment having mainframe based storage using FICON and an open system based storage using FC. The invention bridges the heterogeneous environment while maintaining DASD/Disk neutrality. The bridge is a gateway programmed to permit applications residing on the mainframe or open system to map logic paths thereby eliminating or reducing the need to store data prior to transmission. The gateway is able to appear to the first storage device as a standard CTC connection to a mainframe, while appearing to the open system as a number of SCSI tape drives.

### PRIORITY

This application claims the benefit of U.S. Provisional Application Ser. No. 60/728,036, filed Oct. 17, 2005, which is incorporated herein in its entirety by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates to data transfer and more particularly to the transfer, translation and/or conversion of data in a heterogeneous storage network.

### BACKGROUND OF THE INVENTION

As data continues to grow inside of companies it has become readily apparent to these companies, especially those with large data warehousing installations, that they have a real need for high-speed data sharing between heterogeneous environments consisting of Open Source Systems or servers such as the z/OS server manufactured by IBM and UNIX/Windows servers, mainframes and the like. As customer's acceptance of the value of using Fibre Channel to replace SCSI-attached storage grows, the emergence of Fibre Channel-based data storage networks has become a reality. Currently, these networks generally fall into two distinct categories: The first network, illustrated in FIG. 1, shows a physical disk array shared by multiple open system servers. The second network, illustrated in FIG. 2, shows a disk volume/file and/or backup/restore to Fibre Channel-attached tape transports.

However, these two categories of networks, or any mixture of the networks (see FIG. 3), do not address the needs of the total enterprise data processing environment that is found in most corporations. One of the most critical aspects of this environment is the growing need to share data across the total enterprise's data processing functions.

In today's computing environment, true data sharing exists only on homogeneous platforms. For example, in a z/OS Parallel Sysplex configuration with multiple mainframes acting together as a single system all processors in the Sysplex typically run on similar platforms and have read and write access to data on shared disk storage. Applications running on separate processors can simultaneously read the same copy of the data, but write access requires the data to be locked by a single application in order to preserve data integrity. The process of locking data is managed by hardware and software independent of the disk storage subsystem.

Another example of true data sharing currently used is a pSeries cluster configuration with shared-disk architecture. Clustering technology allows a group of independent nodes to work together as a single system, and in a shared-disk architecture, each node can be connected to a shared pool of disks and its own local disks. All of the nodes have concurrent read and write access to the data stored on the shared disks. As with the z/OS Parallel Sysplex, write access requires the data to be locked by the node requesting the write to preserve data integrity. This locking process is also managed by software independent of the disk storage subsystem.

In corporations, database environments are the repository of the corporate data, and two common scenarios exist, 1) The data processing environments have both z/OS and UNIX/Windows systems, and 2) each of these environments have separate database environments processing information. Because of the difficulty dealing with disparate data types, the situation has been referred to as the “islands of information” problem, and solving this problem of data interchange is key to any successful data warehousing implementation.

Data warehousing is the method of consolidating information (stored in data bases) from one platform to another, or in other words bridging the islands of information. Data warehousing involves the transformation of operational data into informational data for the purpose of analysis. Operational data is the data used to run a business. This data is typically stored, retrieved, and updated by an Online Transactional Processing (OLTP) system. An OLTP system may be, for example, a reservation system, an accounting application, or an order entry application.

Informational data is typically stored in a format that makes analysis much easier. Analysis can be in the form of decision support (queries), report generation, executive information systems, and more in-depth statistical analysis.

In almost every large enterprise, three facts exist: 1) z/OS applications collect the results of the organization's day-to-day activities (it is estimated by IDC and other research firms that 60-70% of corporate data falls into this category); 2) the amount of data that is being collected is quite large; and 3) it is more productive to analyze this information on an UNIX or Windows system. Given these factors, it becomes clear that large amounts (gigabytes to terabytes) of information must be moved, or shared. All of this must be done without affecting the normal operations of the enterprise while the information being shared between the environments must handle the heterogeneous nature of UNIX/Windows to z/OS systems connectivity.

In order to share this data, corporations must decide between the three most common methods: 1) existing Local Area Networks (“LAN) technology, 2) existing pseudo-shared storage hardware, and 3) existing channel technology.

Products currently exist that use some form of inter-process communication, such as Transmission control Protocol and Internet Protocol (“TCP/IP”) sockets, or Message Queue Facility (MQF), to transfer data between the heterogeneous environments. Those using TCP/IP to transfer data between storage devices in a corporation have the same concerns as any computer-to-computer transmission over the Internet. In particular, the use of the TCP/IP sockets creates security concerns for the data stored in the storage devices. However, these products have the undesirable result of using up valuable networking resources, or computational resources, that are otherwise used for data processing needs of the user.

MQF is considered to be a “store and forward” technology. In particular, systems using MQF store messages (data) prior to transmission. Typically, the two systems do not connect to the queue at the same time. Therefore, there is no guarantee of a seamless end-to-end transfer of data in a small window.

Others have attempted to use the I/O bus to control the transmission of data between heterogeneous environments. For example, U.S. Pat. No. 5,906,658 to Raz uses the I/O bus for inter-process communication to transfer messages between a plurality of processes that are communicating with a data storage system. However, it relies on the MQF to transmit the message between the computers. Since this technology is an embedded store and forward technology, the data transfer is not implemented in a fashion that provides an end-to-end pipe with connection and session characteristics, with the semantics needed by applications to guarantee the delivery of data in real time.

Another system using I/O bus to control the transmission of data between storage devices is described in U.S. Patent Publication Number 2002/0004835 to Yarborough. This publication is different than that of Raz since it allows the application to use the I/O bus directly. However, it has the same shortcomings since it also relies on a store and forward MQF technique.

Another product that addresses the problems of transferring data between heterogeneous environments includes Alebra's Parallel Data Mover™ (“PDM”). The PDM, a software application, typically has several components installed on z/OS based mainframe computers and on open systems such as UNIX, Linux and Windows servers.

Currently, there is no data sharing, as defined above, that provides for concurrent read/write and that manages the locking process to preserve data integrity for a heterogeneous (z/OS and UNIX/Windows) storage networks or environments. Additionally, there is currently no data sharing solution that conveniently and seamlessly converts data in a heterogeneous storage network system.

There is currently a need in the industry for a product that is able to transfer data files resident on the storage system of one computer or processing system to the data files resident on another computer or processing system, and to be able to move this data in a generally small window.

### SUMMARY OF THE INVENTION

The invention provides for facilitating data sharing or data transferring and/or conversion over FICON-FIBRE channel connectivity, while maintaining DASD/Disk neutrality. In an example embodiment of the invention, the invention is a FICON-FC-FCP bridge creating a bridge to allow parallel movement of data without the need for MQF. To bridge the FICON-FC-FCP, the invention uses a gateway connected generally between a first storage or server device and a second storage or server device. This gateway facilitates the parallel movement of data by controlling the rate of transmission, the conversion between protocols, and the simultaneous read/write ability of multiple storage and/or server devices in a heterogeneous storage network system.

An object of the invention is to reduce server (mainframe and UNIX/Windows) central processing unit (CPU) cycles for data sharing/copying without the need for TCP/IP or a VTAM stack.

Another object of the invention is to provide a high security-channel-based infrastructure.

Another object of the invention is to provide high bandwidth to the network.

Still another object of the invention is to provide a gateway that emulates more than one data storage or server device to permit seamless conversion of data between the different devices.

Yet another object of the invention is to provide an end-to-end pipe for the transmission of data at a high throughput rate with session oriented semantics. Such semantics allow the applications at either end of the pipe to be informed of errors at the other end of the pipe, allowing such applications to know that the communication channel is broken, and to take recovery actions that are appropriate to the applications.

Still yet another object of the invention is to allow the mapping of addresses in one I/O bus attached to one computer system to addresses in another I/O bus attached to another computer system.

A further object of the invention is to provide either end with the address mapping information to allow discovery by the applications at either end of the pipe, allowing such applications to automatically configure the end to end communications channel, shielding the applications from having to know the I/O addresses being connected.

Still another object of the invention is to guarantee that the data traversing an implementation of this invention, from one I/O bus to another, does not get corrupted due to hardware or software defects in the implementation.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an illustration of a Fibre Channel-based data storage network that utilizes physical disk arrays that are shared by multiple open system servers.

FIG. 2 is an illustration of a Fibre Channel-based data storage network that utilizes disk volume/file backup/restore to Fibre Channel-attached tape transports.

FIG. 3 is an illustration of a mixed Fibre Channel-based data storage network of FIGS. 1 and 2.

FIG. 4 is an illustration showing various data sharing processes.

FIG. 5A is a schematic of the invention illustrating a simplified network.

FIG. 5B is an example embodiment of the invention showing a gateway device between first and second storage and/or server devices.

FIG. 6 is another example embodiment of the invention showing a gateway between a first storage device and a FC SAN that is in communication with a plurality of second storage or server devices.

FIG. 7 is a another example embodiment of the invention showing a gateway between a FICON Director connected to a first storage device and a FC SAN that is in communication with a plurality of second storage or server devices.

FIG. 8 is another example embodiment of the invention showing a plurality of gateways each of which are disposed between at least one FICON Director connected to a first storage device and a FC SAN that is in communication with a plurality of second storage or server devices.

FIG. 9 is a diagram of the parallel flow of data through the gateway.

FIG. 10 is a rearview of the gateway depicting connections to various components operatively disposed therein.

FIG. 11 is a screen shot of a graphic user interface that is utilized by a user to manage the flow of data through the system.

FIG. 12 is a schematic illustrating mapping of I/O addresses of the invention.

FIG. 13 is a schematic illustrating a CTC connection and a FC connection with the gateway.

FIG. 14 is a flow diagram illustrating the initialization of the gateway program utilized to bridge the mainframe and the open system.

FIG. 15 is a flow diagram illustrating commands issued by the program.

FIG. 16 is a flow diagram illustrating the binding of Logic Unit Numbers in the gateway to which is used to pass the data between a pdm character driver and a SCST Subsystem.

FIG. 17 is a flow diagram illustrating the read and write commands to the Logic Unit Numbers in the gateway.

FIG. 18 is a flow diagram of a SCSI Inquire command that inquires about a channel connection for read and write commands.

FIG. 19 is a flow diagram illustrating the mapping of I/O information between the MVS and SCSI LUN.

FIG. 20 is a flow diagram illustrating the method of checking for data corruption during data transmission from the open system to the mainframe.

FIG. 21 is a flow diagram illustrating the method of checking for data corruption during data transmission from the mainframe to the open system.

FIG. 22A is a flow diagram illustrating a method of having the SCSI initiator RESERVE and/or RELEASE a channel prior to and/or after an application on the open system reads or writes data.

FIG. 22B is a flow diagram illustrating system issue calls.

FIG. 23 is a flow diagram illustrating a method for a pdm character driver to emulate a SCSI device and the treatment of its online and offline states.

The preceding description of the drawings is provided for example purposes only and should not be considered limiting. The following detailed description is provided for more detailed examples of the present invention. Other embodiments not disclosed or directly discussed are also considered to be inherently within the scope and spirit of the present invention.

### DESCRIPTION OF THE PREFERRED EMBODIMENT

Example embodiments of the invention illustrated in the accompanying Figures will now be described with the method, process and system for moving or sharing data between heterogeneous environments being indicated by the numeral 10.

I. Network Systems

Network systems 12 are typically used for data processing where information is transferred between devices such as mainframes, servers and computers or among servers and/or storage devices. These devices typically include one or more processing means such as a central processor (CPU) and storage means for storing data and other peripheral devices. The connections between the data processing devices can be made through a fabric of optical fibers, routers, switches and the like. The optical fibers and switches create channels by which the information or data is transmitted between the devices.

The storage devices and/or servers and computers typically include a number of storage disks for storing programs, data and the like. Central processing units in the devices permit the high speed transfer of data there between via the optical fibers.

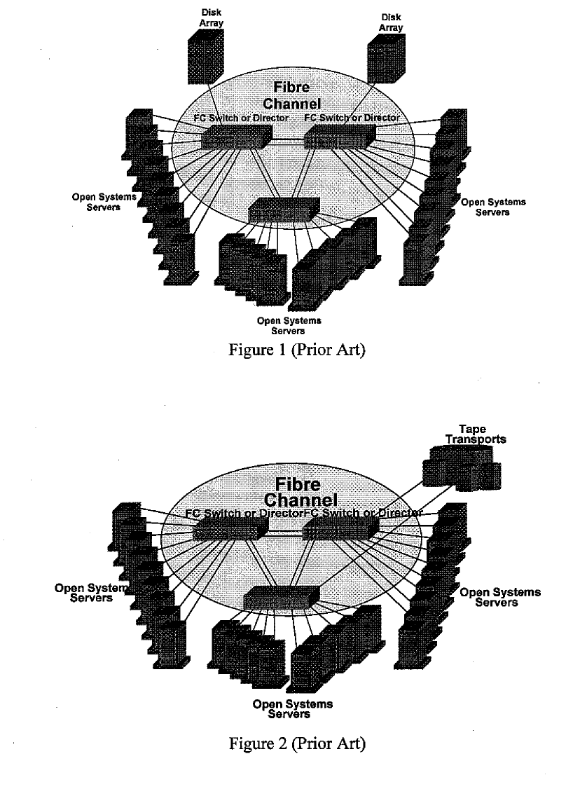

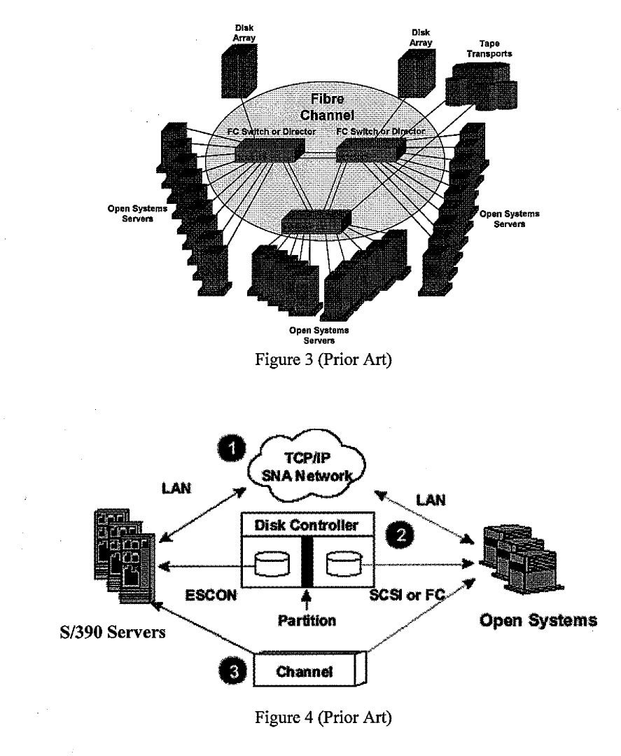

Referring to FIGS. 1-4, typical Fibre Channel-based data storage networks are illustrated. Referring particularly to FIG. 1, the Fibre Channel storage network includes at least a pair of open system servers, Fiber Channel (FC) switches and at least one disk array. Referring to FIG. 2, the Fibre Channel storage network includes at least a pair of open system servers, FC switches and at least one tape transport. Referring to FIG. 3, the Fibre Channel storage network includes at least a pair of open system servers, FC switches and a mixture of disk arrays and tape transports.

Traditional storage network systems were homogenous, i.e., systems using the same operating systems or other software, such as Unix/Windows or an Open Source software. Today, however, modem storage network systems are heterogeneous using both mainframe, i.e., z/OS, based storage devices that use fiber connectivity (FICON) and open systems, i.e., Unix/Windows, based storage devices that utilize Fibre Channel (FC). The present invention provides a device, system and method that simplify the transmission of this heterogeneous data between mainframe base storage systems in a FICON environment and open systems based storage systems in a Fibre Channel environment.

II. Simplified Network System

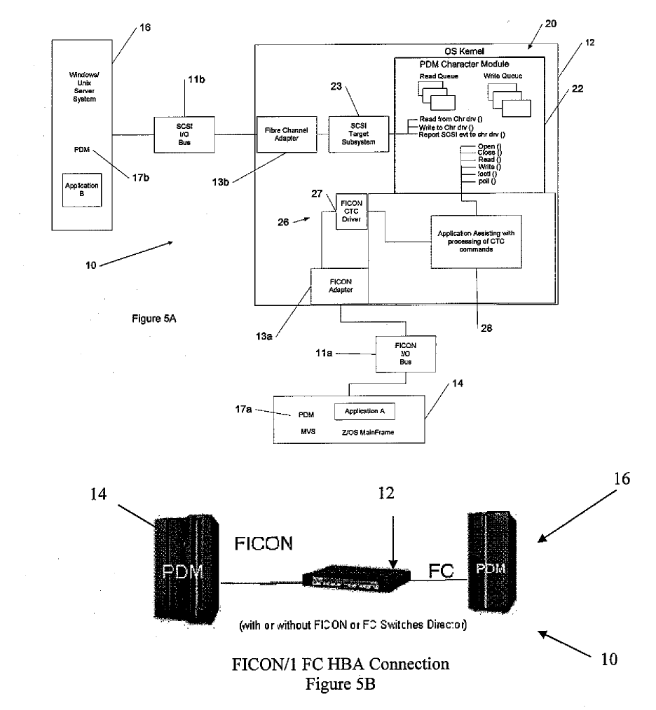

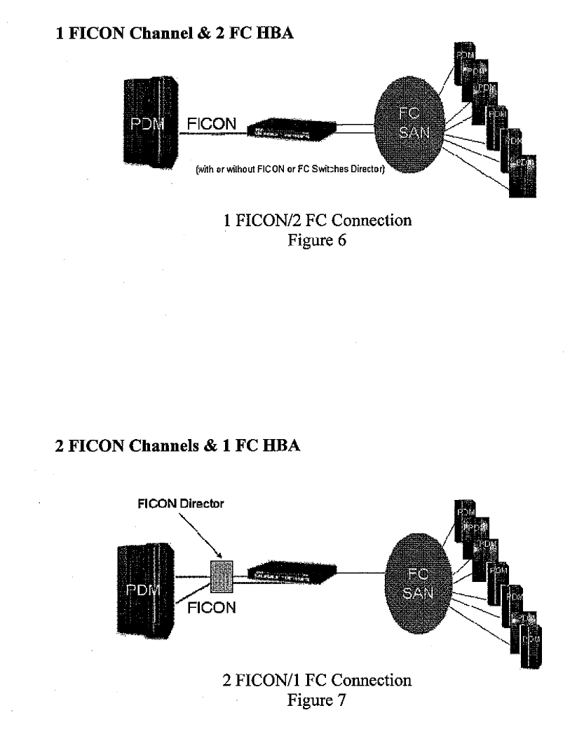

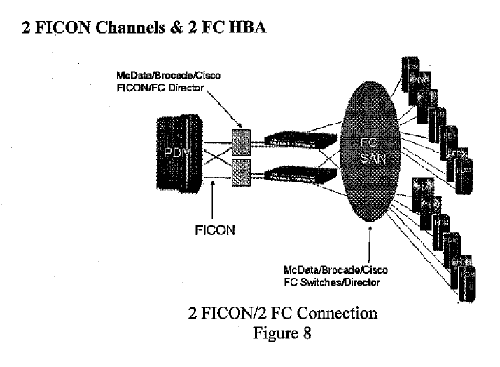

Turning now to FIGS. 5A-8, the heterogeneous network control system 10 of the present invention is simplified compared to the traditional Fibre Channel-based data storage networks of FIGS. 1-4. Referring particularly to FIG. 5A, the network control system 10 includes a data control means such as a bridge or a gateway 12 that is connected to the network 10 via optical fibers. The gateway 12 is disposed in communication with at least one first storage and/or server device 14 and at least one second storage and/or server device 16. In one embodiment, the first storage/server device 14 can be coupled to the gateway 12 by FICON in communication with a FICON input/output (I/O) Bus 11a. The second storage/server device 16 can be connected to the gateway 12 via FC in communication with a SCSI I/O Bus 11b. Through this connection the gateway 12 facilitates the parallel transmission and/or conversion of data between the first 14 and second 16 storage/server devices.

Other storage and/or data processing systems can also be used in conjunction with or in place of the first 14 and second 16 devices. For example, in one embodiment of the invention, the first storage/server device 14 can be a Mainframe such as the z/Series or S/390 servers manufactured by IBM and the second storage/server device 16 can be a Server such as SUN, pSeries or Windows servers. Any type of storage or server device capable of connecting to FC, FICON or other network connectivity may be used with the present invention.

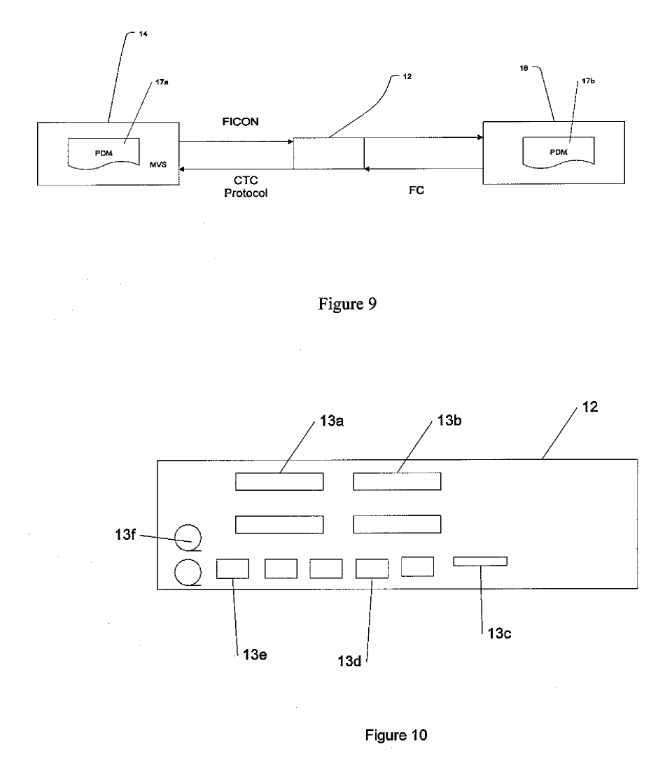

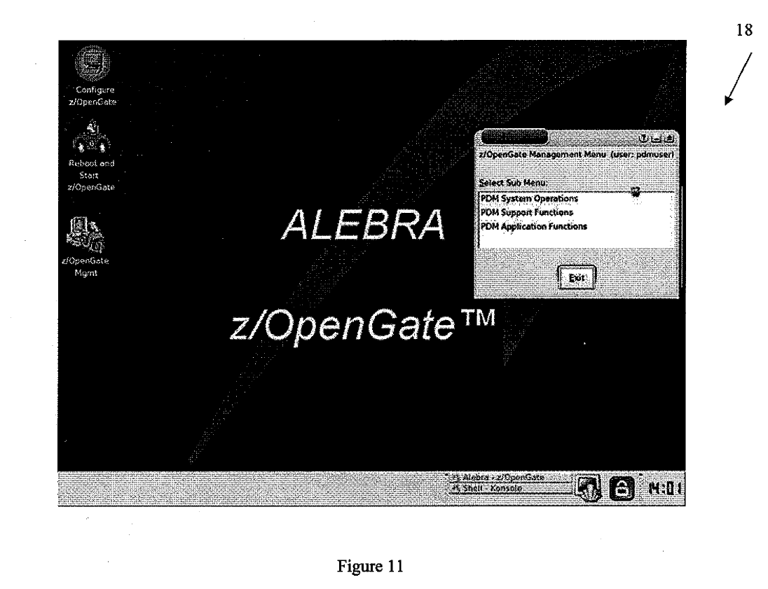

Referring to FIGS. 5A and 9, the gateway 12 facilitates the transmission and/or conversion of data in the heterogeneous network 10 by communicating with a first data transmission program or means or a parallel data moving program or means (PDM) 17a, residing on the first 14 and a second data transmission program or means or parallel data moving program or means (PDM) 17b, residing on the second 16 storage/server device.

III. Gateway Hardware Components

Referring to FIGS. 5A and 10, the gateway 12 includes a chassis such as the Intel® Server Chassis SR2400. The gateway 12 chassis includes at least one FICON channel interface (channel 0) 13a for connecting to the first storage/server device 14. The FICON channel interface 13a can include a card manufactured by manufacturers such as Bus-Tech, Inc and the like. The gateway 12 can also include at least one Fibre Channel HBA (Host Bus Adapter) 13b for connecting to the second storage/server device 16. The Fibre Channel HBA 13b for connecting to the second storage/server 16 can include a card manufactured by manufacturers such as Qlogic and the like.

The gateway 12 may also include one or more USB connections 13d, and/or at least one Ethernet connection 13e for permitting a user to connect to the Internet or other network. The gateway 12 can also include one or more connectors 13f for connecting a monitor, a keyboard, a mouse or other peripheral devices. A user can use the peripheral devices to access a graphic user interface (GUI) 18 residing on the gateway 12 to control the transmission and/or conversion of data in the heterogeneous environment.

IV. Gateway Software Components

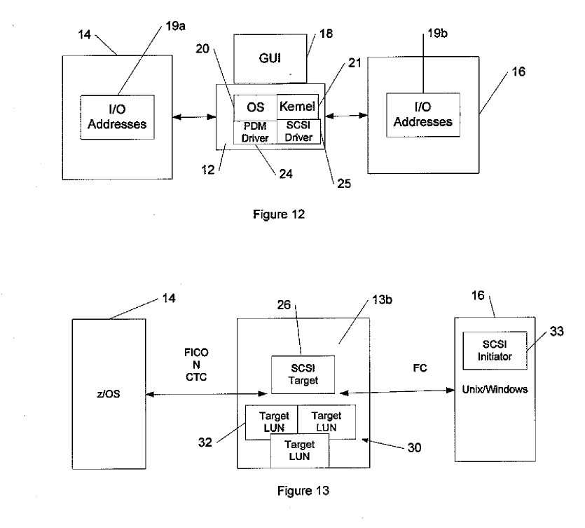

Referring to FIGS. 5A and 12, the gateway 12 also includes an operating system (OS) 20 residing on the gateway 12. The OS 20 includes an OS Kernel 21. The OS Kernel 21 includes a PDM Character Module or data control means 22 and a SCSI target subsystem 23. The PDM Character Module (PCM) 22 includes a pdm character driver 24 for controlling the reading and writing of data between the first 14 and second 16 storage/server devices. The PCM 22 also includes a SCSI driver 25.

In one embodiment, the gateway 12 also includes a channel-to-channel (CTC) control module 26 having a FICON CTC driver 27 and a CTC assisting application 28 connected between the FICON interface 13a and the PCM 22. The CTC control module 26 facilitates the control of the channel-to-channel connection between the first storage/server device 14 on the FICON network and the second storage/server device 16 on the SCSI network.

IV. Control of Data via the Gateway

Through a keyboard or other peripheral device a user can use the GUI 18 to configure the parallel transfer and/or conversion of data between the first 14 and second 16 storage/server devices. Referring to FIG. 12, each of the first server/storage devices 14 and the each of the second server/storage devices 16 typically includes a device address 19a and 19b that identifies it on the network. As illustrated in FIG. 5A, each of these first devices 14 and each of the second devices 16 include one or more applications that may be needed by users. At least one storage means 30 having at least one Logic Unit Number (LUN) 32 that identifies it on the network is disposed in gateway 12. The storage means 30 can include a disk, tape or any other type of device capable of at least temporarily storing data.

Continuing with FIG. 12, the GUI 18 can be used to allow a user to map device addresses 19a of the first device 14 to the LUNs 32 of the storage means 30, thereby creating multiple logical data paths to be dynamically shared across Logical Partitions (LPARs) in a Sysplex environment. Likewise, the GUI 18 can be used to map addresses |19a| of the second device 16 to the LUNs 32 of the storage means 20 in the gateway 12.

The pdm character driver 24 and a SCSI target subsystem 23 will allow an application residing on either the first device 14 or the second device 16 to send and/or receive data packets to the SCSI target driver 25 for the Fibre Channel cards 13b. In one embodiment, as illustrated in FIG. 13, the pdm character driver 24 directs the data transmitted on a FICON channel CTC data path from the first device 14 to the appropriate Target LUN 32 residing on the gateway 12, which then passes it on through the Fibre Channel network to a SCSI Initiator 33 of the second device 16. Correspondingly, data received from the SCSI Initiator 33 and transferred to the pdm character driver 24 by the SCSI Target LUN 32 interface is directed to the appropriate FICON channel device path by way of an application interface for fulfillment of a READ command presented to the channel by a remote application. By providing a well defined interface for delivery and receipt of SCSI commands and responses, as well as providing a well defined interface for delivery and receipt of Channel CTC commands and responses, the pdm character driver 24, a seamless data bridge or gateway between Fibre Channel and FICON systems is provided.

In one embodiment of the invention, the pdm character driver 24 and the associated SCSI target driver 25 hide or mask at least a portion, but can mask all of the details, of the SCSI commands and interface, as well as the Channel commands and interface; and in one embodiment, can allow a maximum of 256 concurrent file openings. Although a maximum of 256 concurrent file openings are disclosed it is possible to include more or less than 256 concurrent file openings. Therefore, the number of concurrent file openings should not be considered a limitation but rather an example. When each file is open a file descriptor is assigned to the pdm character driver 24 that will eventually be associated with a unique logical unit number (LUN) of the SCSI target driver 25.

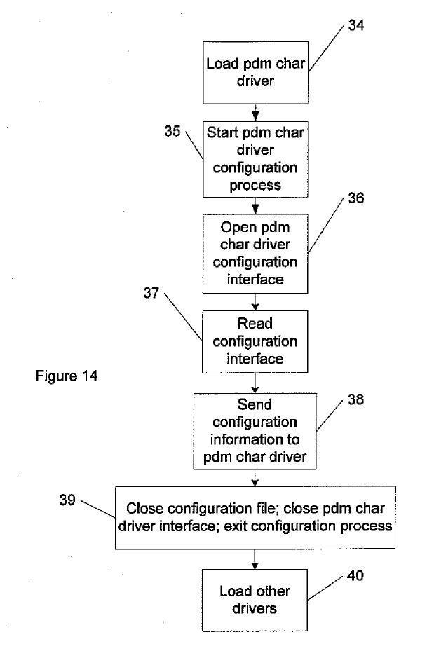

Referring to FIG. 14, the pdm character driver 24 is loaded at step 34. Then the pdm character driver 24 configuration process is started as shown in step 35. This process causes a special or configuration interface to the pdm character driver to be opened, as illustrated in step 36. At step 37, the configuration file is read and processed, and, in step 38, the configuration information is passed to the pdm character driver 24 using this special interface. The configuration process is ended, as illustrated in step 39, and then the other component drivers of the Fibre Channel and SCSI Target subsystem 23 are loaded in step 40,

In one embodiment, the configuration file of step 39 can contain the following information for each logical unit:
a) the adapter number;
b) the LUN; and/or
c) product information about the type of emulated tape drive, can include for example purposes only:
   i) 8 byte vendor id (e.g. “EXABYTE”);
   ii) 16 byte product id (e.g. “EXB-8500”); and
   iii) 4 byte revision level (e.g. “0101”)
   iv) 9 byte Multiple Virtual Storage (MVS) system SMF ID and channel device number (e.g. “MVS3:050F”)

The name of the active configuration can be /etc/pdm/pdmxmapac or any other naming convention. The name of the special device can be named “/dev/pdm” or any other naming convention. No particular naming convention is required for operation of the invention.

V. Reading and Writing of Data

One of the advantages of the invention is its ability to read and/or write data without corrupting it for others that may need to access it. This is accomplished, in one embodiment, by delivering the pdm character driver 24 to an interface card manufacturer as a binary Red Hat Package Manager (RPM) package. As illustrated in FIG. 5A, the pdm character driver 24 of the PDM Character Module 22 can control the read and write functions on the first device 14 and the second device 16.

Referring to FIG. 15, control of the read and write functions by the pdm character driver 24 can include a start script pdm_scsi 42 that is typically installed in a directory such as /etclinit.d. The start script 42 can generally accept two arguments—start and stop. Other arguments are also possible and should be considered to be within the spirit and scope of the invention. As illustrated in FIG. 15, a start command pdm_scsi start 43 can load all of the driver components at step 44, create a device special file in the dev directory at step 45, and parse the configuration file at step 46.

The pdm character driver 24 can execute a stop command pdm_scsi stop at step 47 that will unload all of the target driver components from the kernel 21 at step 48. If the configuration is changed, the script started at step 42 can be called to start and stop the interface at step 49, or the system can be rebooted at step 50. In one embodiment, the pdm character driver 24 can execute a debug command pdm_scsi debug at step 51 to set diagnostic values for the driver components loaded at step 52, as well as to turn on and/or off diagnostics programs at step 53.

Referring back to FIG. 5A, in one embodiment, the gateway 12 can support blocking and/or non-blocking read( ) and/or write( ) system calls. The gateway 12 can also support ioctl( ) and poll( ) system calls. Referring now to FIG. 16, when a user wants to access data on either the first device 14 or the second device 16, a CTC application 28 on the gateway 12 can open, for example, the PDM target device such as the second device 16 at step 54a. The application can then bind to a particular LUN 32 at step 54b. In an example embodiment, it can only bind to a free LUN 32, i.e. one that has not already been bound, and it must be a LUN 32 that is configured.

Once the CTC application 28 binds to a particular LUN 32 at step 54b the pdm character driver 24 can queue data blocks on two linked lists for each logical unit. As illustrated in FIGS. 5A and 16, the two linked lists include one for a write direction at step 54c and one for a read direction at step 54d. In one embodiment, the user can specify the maximum amount of queued data in the bind ioctl system call, with a definable default of for example 1 megabyte. Other definable values greater than and/or less than 1 megabyte are also possible. The linked lists can be a data structure visible to the target mid-level subsystem 23 for a Linux (SCST) device handler 60. The linked lists created in steps 54c and 54d will be the mechanism used to pass data between the character driver 24 and the SCST subsystem 23.

Referring to FIG. 17, the application opens a data path interface to the pdm char driver 24 in step 55. It then issues an ioctl( ) to the pdm char driver 24 to BIND to a particular LUN 32, as illustrated in step 56. An ioctl( ) to the pdm char driver 24 is then issued to inform the pdm char driver 24 that the channel I/O device associated with the LUN 32 is ONLINE in step 57. Until step 57 is completed, the pdm char driver 24 will consider the channel connection to be not operational, and all SCSI READ and WRITE commands will fail with a SCSI sense code such as “NOT READY” or the like. Data can then be transferred between the channel and SCSI I/O interfaces. As illustrated in step 58, data the application reads from the channel I/O device as a result of a CTC WRITE command executed at MVS and writes it to the character driver 24 for fulfillment of a subsequent SCSI READ command received from the SCSI initiator 33. In step 59, the other direction of data transfer is indicated, whereby the application reads data from the pdm char driver 24, which was delivered as a result of a SCSI WRITE command, and writes it to the channel I/O device when an eventual CTC READ command is processed. When data transfer is completed, the application can issue an ioctl( ) to the pdm char driver across 24 to UNBIND from the LUN 32, and close the data path to the pdm char driver 24, as indicated in step 60.

In one example embodiment, while the present invention includes a character device, in fact, data is read and written in blocks, which are received and transmitted on the Fibre Channel card 13b as packets. In this example embodiment, only a complete block of data can be read or written. The amount of data returned on a read operation represents what was received in a complete SCSI WRITE command from the SCSI initiator 33 on the second device 16. If a block size requested on the read( ) system call is not large enough to contain the entire received block, an error can be returned to the caller. Therefore, in this embodiment the caller should always supply the maximum data packet size to the read( ) system call. Read( ) and write ( ) commands can return with −1 to indicate an error or SCSI event. This error value termed an errno value will indicate what type of SCSI event or error has occurred.

In one embodiment, several ioctl calls are provided in the pdm character driver 24 of the present invention, and are discussed below. These data structures are typically defined in the header file which can be named pdm_ioctl.h, or any other naming convention, and can be included by any application interfacing to the pdm character driver 24.

In an example embodiment of the invention, the data structure used in the ioctl system call to bind to a LUN 32 can include:

typedef struct pdm_bindlun
{

| | |
|---|---|
| int AdapterNumber; | /* adapter number of fibre channel card */ |

| | |
|---|---|
| int LogicalUnitNumber; | /* LUN, in the range of 0 to 255 */ |

| | |
|---|---|
| int MaxQSize; | /* |

* max amount of data to be queued in
kernel *for
this logical unit. If zero, MaxQSize will
*be set to
a default */

int Reserved[16];

} pdm_bindlun_t;

The ioctl command to be used is PDM_IOCSLUN.
#define PDM_IOCSLUN _IOW(‘=’, 1, pdm_bindlun_t)

Similarly, the following data structure can be used by the application to report various channel events:

typedef struct pdm_report_chan_ev
{

| | |
|---|---|
| int ChannelEvent; | /* Type of Channel Event reported */ |

intReserved[16];

} pdm_report_chan_ev_t;
#define PDM_IOCRCHANEVENT _IOW(‘=’, 3, pdm_report_chan_ev_t)

/* Report Channel Error */

/* Types of channel events reported in PDM_IOCRCHANEVENT ioctl */

| | |
|---|---|
| #define CHN_ONLINE | 1 /* Channel is online */ |

| | |
|---|---|
| #define CHN_OFFLINE | 2 /* Channel is offline */ |

| #define CHN_EOF | 3 /* End of File received on |
|---|---|
| | Channel */ |
| #define CHN_EQUIPMENT_CHECK | 4 /* Equipment Check */ |
| #define CHN_SYSTEMRESET | 5 /* System Reset */ |

| | |
|---|---|
| #define CHN_SELECTIVERESET | 6 /* Selective Reset */ |

| #define CHN_HALTIO | 7 /* Halt I/O */ | |
|---|---|---|
| #define CHN_DATACHECK | 8 /* Data Check */ | |
| #define CHN_DATAUNDERRUN | 9 /* Data Under Run */ | #define |

CHN_NOOP 10 /* NOOP rcvd on channel - flush data*/

#define CHN_UNDEFINEDERROR64 /* Unknown Error */

The foregoing should be considered as example data structures for binding the LUNs 32 and reporting of channel events. Other data structures are possible and should be considered to be within the spirit and scope of the invention.
VI. Additional Features

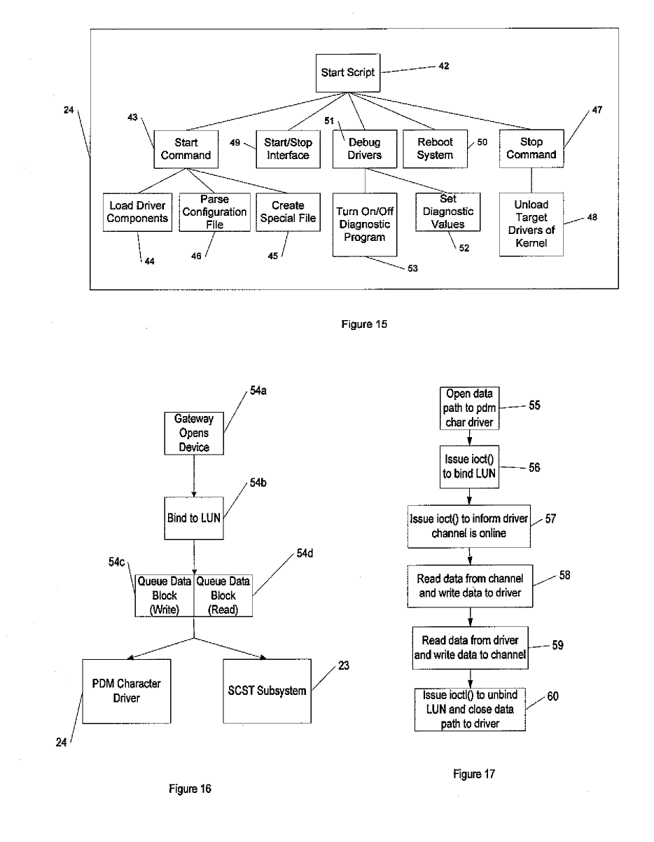

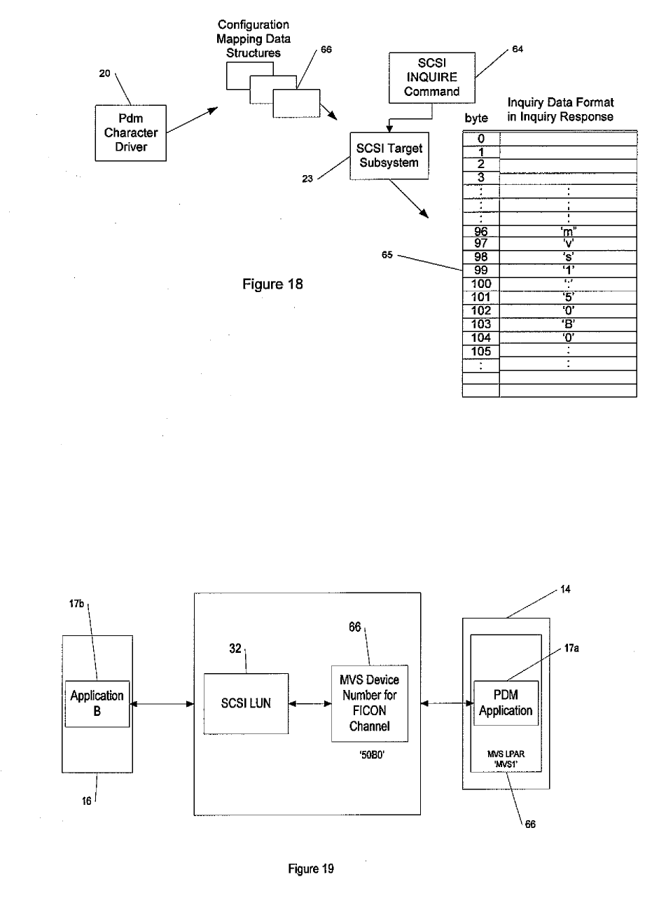

Referring to FIGS. 18 and FIG. 19, in an example embodiment of the invention, the pdm character driver 24 makes visible to the SCSI target subsystem 23, residing in gateway 12, data structures 66 that contains the configuration information that maps a SCSI target LUN 32 to a FICON CTC device. This configuration information may include, for example, a 4 byte MVS system SMF ID of a MVS LPAR, which controls the execution of PDM application 17a on system 14, as well as the MVS Device Number (4 hexadecimal digits) that application 17a uses to gain access to a particular FICON channel device.

When the SCSI target subsystem 23 processes a SCSI INQUIRE command 64 transmitted from the SCSI initiator 33 as a result of application 17b on system 16 opening the SCSI device, it places this information in vendor specific parameters starting at byte 96 of the standard INQUIRY data that is returned to the initiator 33 in the response to the INQUIRE command. In FIG. 18, for example, the INQUIRE response 65 shows that the target LUN 32 is mapped to a FICON channel device with an MVS Device Number 66 of hexadecimal 50B0 that is accessed by an application on an LPAR with MVS SMF ID “MVS1”. The application 17b on the second device 16, may access this information from the SCSI initiator 33 to verify that the SCSI session is, in fact, associated with the correct FICON device used by application 17a on system 14.

This can be extended, of course, to include all of the configuration information needed to map SCSI target LUNS 32 to FICON CTC devices. For example, in addition to putting the information in the SCSI INQUIRE response, as described above, CTC command packets can be defined which can contain the configuration mappings. This information can be used by the application 17b at the SCSI end of the communications endpoint of the second device 16 or the application 17a at the FICON end of the communications endpoint of the first device 14 to discover all of the mappings of the I/O addresses at one end of the communications connection (e.g. SCSI logical unit number 32) and I/O addresses at the other end (e.g. MVS Device Number of the FICON channel device 66). This information can then be used by applications at either end to build configuration mapping information automatically, alleviating users of the applications from knowing the specific I/O addresses embodied in an implementation of this invention.

It is known that when data is transmitted there is always the chance that it will be corrupted. In one embodiment of the invention, a method is provided for providing a means of ensuring that the data delivered at one end of the communication channel is not corrupted by defects when it is delivered at the other end of the communication channel. For example, as illustrated in FIGS. 13, 20 and 21, where one end is a SCSI interface and the other end is a CTC interface, the CTC protocol can use a 4 byte cyclic redundancy check (CRC) value for the data being delivered in the CRC command, and optionally a 4 byte field in the application data can be reserved for carrying this CRC as the data packet travels from one interface to another.

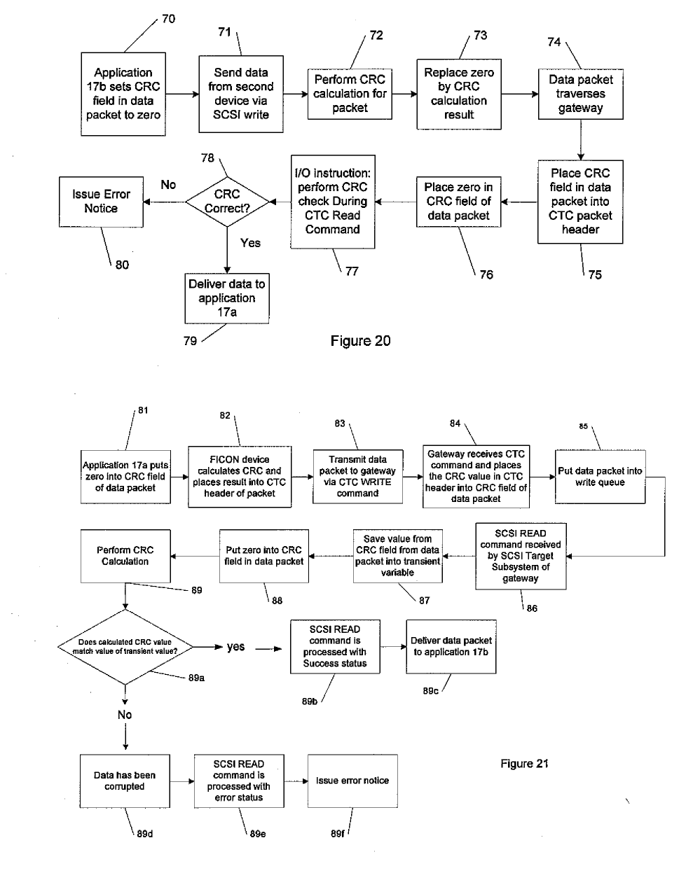

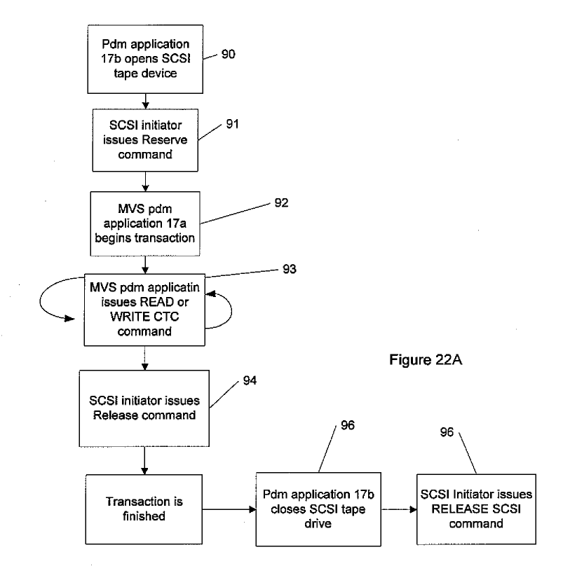

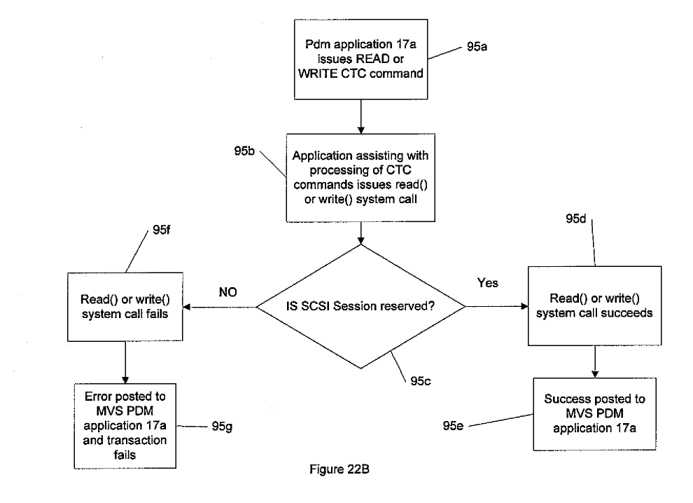

Referring to FIGS. 20 and 21, when a data packet is sent from the application 17b on the second device 16, at step 70, it sets the CRC field in the data packet 70 to zero and issues a SCSI WRITE command as illustrated in step 71. A CRC calculation is performed by the SCSI target subsystem 23 of gateway 12 on the data packet at step 72. The calculated CRC is then inserted into the CRC field of the data packet at step 73. Step 74 illustrates the data packet traversing through gateway 12. As the packet is delivered to the FICON I/O device in gateway 12, the CRC field is taken from the data packet and put into the CTC header at step 75 containing the CRC while zero is replaced in the corresponding field in the data packet at step 76. The I/O instructions on the mainframe perform a CRC check of the data as part of the processing of the data packet during a channel CTC READ command at step 77. If data has been corrupted as it travels through an implementation of this invention it is detected by the I/O processing at the mainframe and an error notice is generated at step 80. Otherwise, the data has not been corrupted, and is delivered to application 17a on the first device 14 as shown in step 79.

Referring to FIG. 21, application 17b on the first system 14 places a zero in the CRC field of the data packet in step 81, and issues a CTC WRITE command. In step 82, the I/O instruction calculates a CRC value and places it in the header of the CTC packet. The data packet is then sent from the first device 14 to the gateway at step 83. The packet is received by the gateway 12 in step 84, and the CRC value contained in the header of the CTC packet is placed in the CRC field in the data packet. The data packet traverses the gateway 12 and is eventually placed in the write queue in step 85. At step 86, a SCSI READ command is received by the SCSI target subsystem 23 of the gateway 12. The SCSI target subsystem 23 then stores the value from the CRC field of the data packet into a transient variable in step 87. A zero is then put into the CRC field of the data packet in step 88, and a CRC calculation is then performed on the data packet in step 89. A comparison of the calculated CRC value and the CRC value stored in the transient variable is conducted in step 89a. If there is a match then the SCSI READ command can be completed successfully as indicated in step 89b, and the data packet is eventually delivered to application 17b in step 89c. If the values do not match, it means that it has been corrupted during its transition as indicated in step 89d and the SCSI READ command is completed with an appropriate error status as indicated in step 89e. An error notice is generated and displayed to the user in step 89f. Thus, instead of blindly delivering corrupted data, the applications 17a and/or 17b at either end will get an error indication of this event, and can take error recovery measures. This, of course, is preferred to having data corrupted in transit unknowingly.

VII. Error Processing

The types of errors that can be issued vary and will be discussed in this section as only examples of the types of errors possible. Upon an error during a system call an error code may be displayed to a user on GUI 18. The following are example tables of error codes and their possible associated meanings involving the PDM target driver 24. When a system call fails, it can return a −1 value or any other predetermined value. The value of errno will contain the actual cause of the error.

A. Open Errno Values:

| | |
|---|---|
| ENODEV | More than 256 instances are already open. |
| EIO | Error interfacing with SCST subsystem. |
| ENOMEM | No kernel memory available for LUN structure. |

B. Ioctl Errno Values:

| | |
|---|---|
| ENOLINK | The SCSI initiator closed its device before receiving a |
| | valid end of file indication. |
| EINVAL | Invalid parameter, such as specified LUN is not |
| | configured. |
| EBUSY | There is another open file already bound to the LUN. |
| EFAULT | Bad address or incorrect size of supplied parameter |
| | block. |
| ENODEV | LUN has not been bound. |
| ENOTTY | Invalid ioctl command code. |
| EIO | Error interfacing with SCST subsystem. |
| ENOMEM | No kernel memory available. |

C. Read Errno Values:

| | |
|---|---|
| EAGAIN | The file has been set to non blocking mode, and there is |
| | no data available. |
| EPIPE | SCSI FILE_MARK has been received on a SCSI WRITE |
| | command, indicating that end-of-file condition has been |
| | received. Application should send an appropriate end-of- |
| | file indication on the associated channel ID. |
| ENOLINK | There is currently not a RESERVED SCSI session |
| | associated with this LUN. |
| EINVAL | The data block available is larger than the requested data |
| | size. The maximum size data block is (definable). |
| EFAULT | Bad address or incorrect size of supplied parameter |
| | block. |
| EBUSY | Device has been set off line. |
| ENODEV | LUN has not yet been bound. |
| EIO | Error interfacing with SCST subsystem. |

D. Write Errno Values:

| | |
|---|---|
| EAGAIN | The file has been set to non blocking mode, and the |
| | maximum amount of data is already queued for this |
| | logical unit. |
| ENOLINK | There is currently not a RESERVED SCSI session |
| | associated with this LUN. |
| EFAULT | Bad address or incorrect size of supplied parameter |
| | block. |
| EINVAL | The data block available is larger than the maximum |
| | block size of (definable). |
| EBUSY | Device has been set off line. |
| ENODEV | LUN has not yet been bound. |
| EIO | Error interfacing with SCST subsystem. |
| ENOMEM | Queued data size is less than MaxQSize, but no kernel |
| | memory available |

As stated above, these codes are examples only. A user can define any codes having similar messages and still be within the spirit and the scope of the invention.

The following sections describe protocol issues related to the interplay between channel events and their impact on the CTC processing application 28 and the pdm character driver 24.

VIII. End of File Processing

As illustrated in FIGS. 5A and 9 and discussed above, the CTC processing application 28 of the present invention uses CTC protocol to send and receive packets from the PDM application 17a running on a multiple virtual storage (MVS) operating system of first device 14. This CTC processing application 28 is also involved in transferring files to and from an application 17b on an open systems platform of second device 16 which interfaces to a SCSI tape device driver supplied in the OS of the platform. In addition to determining whether the data transferred has been corrupted, there is also a need to report other end of file conditions in both directions.

This is accomplished in the invention by the PDM application 17a on the MVS system of first device 14 generating a code such as WEOF (X'81 op code), with X'60′ in flags and length of 1. In return, it can expect an immediate response (CE, DE) regardless of whether an end-of-file (EOF) indication has made it to the open systems PDM partner 17b. In this embodiment, this is command chained to a no operation code (NOOP) (X'03′) with X'20′ in flags. The CTC processing application 28, on receipt of the WEOF code can then issue a PDM_IOCRCHANEVENT ioctl command to the files descriptor bound to the associated LUN 32, with the ChannelEvent field set to CHN_EOF. This will cause the pdm character driver 24 to set the file mark bit ON in a subsequently received SCSI READ command, after all current data queued by the pdm character driver 24 has been delivered.

In the other direction, when the pdm character driver 24 receives a SCSI WRITEFILEMARK command, the driver will cause a subsequent read call to fail with the errno value set to EPIPE. All data queued will be delivered to the CTC processing application before delivering this EOF notification. It will be implemented in such a way that the poll command will notify the application that a POLLIN event is available. When the application detects this event, it should respond to a subsequent READ Channel Command Word (CCW) with a unit exception indicating end of data.

IX. SCSI Session

Referring to FIGS. 22a and 22b, the pdm char driver 24 relies on the SCSI initiator 33 reserving with a RESERVE command before issuing read( ) or write( ) calls to succeed, as well as relying on it to release the session with a RELEASE command. The pdm application 17a on system 16 opens a SCSI tape device as shown in step 90 and then the SCSI Initiator 33 issues a SCSI RESERVE command, as shown in step 91. The MVS PDM 17a of first device 14 will not attempt to read or write from the channel until a PDM client 17b on the SCSI initiator 33 of the second device 16 has opened the tape device or other storage means, as illustrated in step 91, because it is considered an error if the read( ) or write( ) system call is made to the pdm char driver 24 while there is no reserved SCSI session associated with the LUN 32 in question. The MVS PDM application 17a then begins a transaction (step 92) and issues READ or WRITE CTC commands as necessary (step 93). MVS PDM 17a then ends the transaction in step 94. The pdm application 17b on system 16 closes the SCSI tape device in step 95 and the SCSI initiator 33 on system 16 issues a SCSI RELEASE command as shown in step 96.

Referring to FIG. 22b and particularly step 95a, the MVS PDM application 17a on the first device 14 issues a READ or WRITE CTC command as shown in step 95a. The CTC processing application 28 then issues a read( ) or write( ) system call, as shown in step 95b. If the SCSI session has been reserved (step 95c) then the read( ) or write( ) system calls succeeds (step 95c) and the success is posted to the MVS PDM application 17a (step 95e). If the SCSI session has not been reserved (step 95c) then the read( ) or write( ) system call fails (step 95f) and an error is posted to the MVS PDM application 17a (step 95g). This error condition may occur, for example, if the fiber channel cable is unplugged during a transaction or if the system 14 on which the PDM application 17b is running is rebooted. In these cases, the pdm char driver 24 will return an error to read( ) or write( ) with an errno value of ENOLINK, as illustrated in step 95d. In this event, the application should indicate an EQUIPMENT_CHECK status on the next READ or WRITE channel command received from MVS, as illustrated in step 95e.

X. Channel Off-Line/On-Line Events

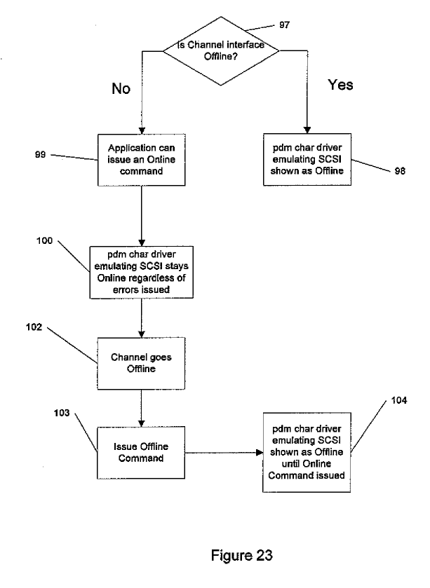

Referring to FIG. 23, when the channel interface is off-line, as indicated in step 97, the SCSI device emulated by the pdm char driver 24 is considered to be in an off-line state, as illustrated in step 98. Any SCSI READ or WRITE command received by the SCSI target subsystem 23 while the device is in an off-line state will fail and an error status will be reported in the command response sent back to the SCSI initiator 33. After opening the device and binding to a LUN 32, CTC processing application 28 must issue a PDM_IOCRCHANEVENT ioctl command, as illustrated in step 99, with the Channel Event field set to CHN_ONLINE. The emulated SCSI device will remain on-line even if other channel errors are reported to the driver (see below), as illustrated in step 100. If the channel goes off-line, as illustrated in step 102, CTC processing application 28 should issue a PDM_IOCRCHANEVENT ioctl command, with the ChannelEvent field set to CHN_OFFLINE, as illustrated in step 103. The emulated SCSI device will remain off line until a subsequent CHN_ONLINE is issued, as illustrated in step 104.

XI. Error Conditions Detected on the Channel Interface

Certain error conditions detected on the channel interface should be reported to the device for all LUN's 32 associated with the channel ID's affected by the error. This is accomplished by issuing a Channel Interface Error (CIE) command such as PDM_IOCRCHANEVENT ioctl with the ChannelEvent field set to at least one of the following codes:
CHN_EQUIPMENT_CHECK
CHN_SYSTEMRESET
CHN_SELECTIVERESET
CHN_HALTIO
CHN_DATACHECK
CHN_DATAUNDERRUN
CHN_UNDEFINEDERROR

These codes are presented for illustration purpose and other codes and naming conventions could be used. Therefore, these should not be considered to be limiting.

In this embodiment, if the emulated SCSI device is in an on-line state, receipt of at least some of these errors will cause it to flush all queued data and to respond to the next subsequently received SCSI command with a SCSI sense code that best describes that condition. This will usually result in the SCSI initiator 33 issuing the command to report an error back to the PDM application 17b on the open systems side of the second device 16, resulting in a file transfer failure if one is in progress. In one embodiment, the under run and data check events will not cause an error to be reported to the SCSI client. If the pdm char driver 24 is able to determine that there is not a file transfer in progress at the time of the event, the system can be configured so that it may not report the error to the initiator 33, but if in doubt, it will always report the error to the next subsequent SCSI command. These events are considered one time events, i.e. once reported, they are considered cleared.

XII. Error Conditions Detected by the SCSI Driver

In general, the nature of SCSI protocol is such that errors can be reported by the target to the device, but errors are never reported from the initiator to the target, i.e. error conditions are reported by the target in response to a received SCSI command. Therefore, unlike channel errors that can occur that will be reported to the pdm char driver 24, the SCSI driver does not report SCSI protocol errors per se to CTC processing application 28.

In one embodiment of the invention, all of the errno return codes that are returned by the SCSI driver can be categorized in three classes:
1. Conditions that are part of the normal processing of the driver.

These should be considered to not really be error conditions. For example, EPIPE is returned when a normal end of file condition has been received in a SCSI WRITEFILEMARK command. The actions that the CTC processing application 28 should take on these conditions have been discussed above. Examples of these errno values are:
a. EAGAIN
b. EPIPE
c. ENOLINK
2. Conditions that result from the application issuing a call to the SCSI driver which violates the protocol specified in this design. This most likely is the result of a logic defect in the CTC processing application 28. These errno values are:
   a. ENODEV
   b. EFAULT
   c. EBUSY
   d. ENOTTY
   e. ENVAL
3. Conditions that result from the driver encountering an unexpected condition from a service requested from a LINUX kernel or the SCST subsystem 23. For example, failure trying to register an emulated tape device for a specific logical unit 32, or failure trying to allocate kernel 21 memory. This condition is most likely the result of a logic bug in one of the components of the SCSI target interface, or a bug in the Linux kernel. It might result, for example, from a memory leak where allocated memory is never returned to the Linux kernel. Examples of these errno values can include:
   a. ENOMEM
   b. EIO

In terms of what the CTC processing application 28 should do on class 2 errors, it is left to the applications 17a and/or 17b residing on the first device 14 and/or the second device 16 as to how to recover. In each of the cases, the driver is left in the state that it was before the error occurred. If the application 17a and/or 17b is able to recover and proceed, it should. However, as these errors indicate that a logic defect is the most likely cause of the error, the best course of action can be for it to cleanly close down the channel id associated with the LUN 32 reporting the error, if channel protocol permits. It can also log diagnostic information that can be inspected post mortem.

Class 3 errors most likely indicate a serious problem in the state of the SCSI target driver, or the kernel 21 itself. For example, if the driver is not able to acquire kernel 21 memory due to a memory leak, it is unlikely that this error will clear itself. It is suggested that the CTC processing application 28 log the fact that the error occurred, close the open driver LUN 32 devices, cleanly take down the channel interface, and reboot the Linux platform. If we consider this to be a situation that is not recoverable, rebooting the Linux server will at least make it possible that the system can be reset and will function when it reboots, avoiding the need for the customer to have to reset the machine via manual intervention.

XIII. Additional Channel Commands

Other than the WEOF and NOOP processing described herein, the PDM application 14 on MVS issues the following channel commands:

X'02′—read, with X'24′ in flags

X'01′—write, with X'24′ in flags

Responses to these commands, other than channel errors, can be CE-DE, CE-DE-UX, or CE-DE-UC.

XIV. Detailed Description of the Interfaces

In use, the pdm character module 22 of the invention acts as an intermediary or bridge for transferring data between an application which sends and receives packets on a channel connected interface and a SCSI target level driver which processes SCSI commands originating from an application 17b connected to a SCSI initiator 33 device driver. As such, it provides a calling interface of entry point routines to be called from the target driver, and a set of routine entry points to be called by the channel connected application.

The CTC processing application 28 can make system calls via the Linux or UNIX system calls read( ), write( ), ioctl( ) and poll( ) as illustrated in FIG. 5A. As described above, the read( ) system call includes the steps or process of determining if the associated channel device is not configured, not bound, or offline. If so, it will return an appropriate error. If a SCSI device associated with the channel device is not currently reserved by a SCSI client, it will return an error indicating that the remote device is not connected. If there is data queued from an earlier delivery of data due to a SCSI WRITE command, it can remove the data buffer from the queue and return the data buffer queued at the head of the read queue to the application. It can also wake up any thread waiting for the size of the read queue to go below its maximum size. Otherwise, if there is an EOF event at the head of the read queue, it will remove this event from the read queue, and return an EPIPE error to the application, indicating that the SCSI transaction has ended. Otherwise, if the control block indicates non-pended I/O, it will return an error indicating that no data is present. Otherwise, it will wait until data is available due to a subsequent SCSI WRITE event.

The write( ) system call includes the steps or process of determining if the associated channel device is not configured, not bound, or offline. If so, it will return an appropriate error. If the SCSI device associated with the channel device is not currently reserved by a SCSI client, it will return an error indicating that the remote device is not connected. If the amount of data currently queued for the associated SCSI initiator 33 is less than the maximum queue size, it will queue the data for a subsequent SCSI READ command. Also, it will wake-up any thread waiting due to empty write queue. Otherwise, if the control block indicates non-pended I/O, it will return an error indicating that the queue is full, or, if the control block indicates pended I/O, the write( ) system call will remain pending until the amount of data drops below the maximum queue size.

The poll( ) system call will control bits of the call structure that indicate whether the user is polling for data available to be read, or polling for the size of the write queue to be less than the configured maximum. If these conditions are met, it will return such indication to the user. Otherwise, it will wait for the condition requested, or wait for an event that causes the associated SCSI session to be released, or some other error event on the SCSI session. In such a case, it will return an error notification to the user.

The processing of the ioctl( ) system call routine is based on the command code passed in the parameter data structure. These commands are grouped into three general classes called Configuration, Channel Event Notification, and Diagnostics. A pseudo code summary of each of the classes is provided in tables 1-3 below.

TABLE 1
CONFIGURATION

PDM_IOCCFGLUNS - Configure mapping between SCSI Target
Logical Units and Channel ID's
PDM_IOCSLUNPRODID - Set the SCSI Product ID vectors for a
particular SCSI Logical Unit,

i.e. the type of tape drive being emulated in the target driver

PDM_IOCSWWN - Set last 3 octets of the SCSI over Fibre Channel
World Wide Number, which

will override the value provided by the board manufacturer.

CHANNEL EVENT NOTIFICATION

PDM_IOCRCHANEVENT - Report one of the following Channel I/O events:
CHN_ONLINE - The channel has come on line. The state of this connection remains on line until

a subsequent CHN_OFFLINE is reported.

CHN_OFFLINE - The channel has gone offline. The state of the connection remains offline until

a subsequent CHN_ONLINE is reported. Causes all subsequent received SCSI READ or WRITE
commands to fail with an appropriate sense code until the channel is brought back on line.

CHN_EOF - A WEOF command has been processed by the application, and a corresponding

FILEMARK bit should be set in a subsequent SCSI READ command completion result.

CHN_EQUIPMENT_CHECK - Equipment Check on channel. This is a one-time event that MAY

cause the next SCSI READ or WRITE command to fail with an appropriate sense code IF there is an active
transaction on the Logical Unit.

CHN_SYSTEMRESET - System Reset on channel. This is a one-time event that MAY cause the

next SCSI READ or WRITE command to fail with an appropriate sense code IF there is an active
transaction on the Logical Unit.

CHN_SELECTIVERESET - Selective Reset on channel. This is a one-time event that MAY

cause the next SCSI READ or WRITE command to fail with an appropriate sense code IF there is an active
transaction on the Logical Unit.

CHN_HALTIO - Halt I/O on channel. This is a one-time event that MAY cause the next SCSI

READ or WRITE command to fail with an appropriate sense code IF there is an active transaction on the
Logical Unit.

CHN_DATACHECK - Data Check on channel. This is a one-time event that MAY cause the next

SCSI READ or WRITE command to fail with an appropriate sense code IF there is an active transaction on
the Logical Unit

CHN_NOOP - NOOP command received on the channel interface. This command can act as the

start or end of a transaction. If it is the start of a transaction, it can be used to synchronize the SCSI and
Channel end points. Any data queued to be transmitted to the SCSI end point can be flushed in that case.

Processing of CHN_EOF
If the associated channel device is not configured, not bound, or offline, return an appropriate

error.

If the SCSI device associated with the channel device is not currently reserved by a SCSI client,

return an error indicating that the remote device is not connected.

Put an EOF Notification Event on the tail of the write queue. Mark the buffer as the last WEOF

queued.

Processing of CHN_NOOP

The CHN_NOOP can be used to make the beginning and end of a transaction. If received by the driver when data is queued to from a SCSI target LUN, the queued data is inspected to determine if, based on the state of the previous transaction, the queued data should be delivered or flush from the queue. This mechanism allows the driver to recover from badly behaved applications on the FICON and Fibre Channel end points, to ensure that improper data is not delivered to an endpoint.

Processing of CHN_OFFLINE

If the associated channel device is not configured or not bound, return an appropriate error.

TABLE 2

If the channel device is already off line, do nothing.
Mark the state of the channel as off line. Purge any buffers on
the read queue. Purge all buffers on

the write following the last WEOF queued, if any.

Processing of other Channel Events (CHN_EQUIPMENT_CHECK,
CHN_SYSTEMRESET,

CHN_SELECTIVERESET, CHN_HALTIO, CHN_DATACHECK)

If the associated channel device is not configured or not bound,
return an appropriate error.
If the channel device is already off line, do nothing.
Purge any buffers on the read queue. Purge all buffers on the
write following the last WEOF

queued, if any.

Put a Channel Error Notification Event on the tail of the write
queue.

TABLE 3
DIAGNOSTICS

PDM_IOCSMDBG - Set tracing mask for this and associated drivers.
PDM_IOCGMDBG - Retrieve the current tracing mask of the SCSI
target driver set.
PDM_IOCGDINFO - Retrieve state information from the pdm_char
module.
PDM_IOCGLINFO - Retrieve state information about a particular
SCSI Logical Unit.

The following entry points are routines to be called by the SCSI Target Driver 23. These routines provide the interface between the target driver's 23 processing of SCSI READ and WRITE commands, and data queued for delivery to the SCSI initiator 33 or the channel application 17a by way of the CTC processing application 28.

When a SCSI WRITE command or SCSI WRITE_FILEMARK command is received by the SCSI target subsystem 23 from the SCSI initiator 33, a call to write_to_ch_drv( ) is made. The write_to_ch_drv( ) command determines if the channel device associated with the logical unit 32 is not configured, not bound, or offline, and returns an error if it is so determined. This will cause the target driver 23 to report a failure to the SCSI WRITE (or WRITE_FILEMARK) command with an appropriate sense code. If the event is kPdmEOF, it will put an EOF event at the tail of the read queue. This indicates that a SCSI WRITE_FILEMARK has been received, signaling an end of the current transaction. If the event is kPdmData, and the size of the read queue is less than the configured maximum, it will put the data buffer at the tail of the read queue. Otherwise, it will wait for the read queue size to go below its configured maximum.

When a SCSI READ command is received by the SCSI target subsystem 23 from the SCSI initiator 33, a call to read_from_ch_drv( ) is made. The read_from_ch_drv( ) command determines if the channel device associated with the logical unit 32 is not configured, not bound, or offline, and will return an error indicated by the kPdmNotify event, if it is so determined. This will cause the target driver 23 to report a failure to the SCSI READ command with an appropriate sense code. If there is an event on the write queue, it will take the event of the queue and return it to the caller. If the event is kPdmEOF, and the buffer is the last WEOF queued, then it will mark the flag indicating the last WEOF queued as a NULL, and the SCSI READ response should be sent to the initiator 33 with the FILEMARK bit set. If the event is kPdmData, then the SCSI READ response should be sent to the initiator 33 with the data contained in the kPdmData event. If there is no event on the write queue, it will wait until there is an event on the write queue.

The SCSI target subsystem 23 uses the report_scsi_evt_to_ch_drv( ) command to report a non-data SCSI event to the pdm character driver 24. The events reported can be session up, session down, and/or session error. These can have any naming convention such as, for example, SCSI_SESSION_UP, SCSI_SESSION_DOWN, or SCSI_ERROR. However, other naming conventions are possible and should be considered to be in the scope and spirit of the invention. If the event is SCSI_SESSION_UP, it can mark the control block of the associated Logical Unit 32 as being reserved, meaning that a SCSI RESERVE command has been received from the remote SCSI initiator 33 as illustrated in FIG. 23. If the event is SCSI_SESSION_DOWN, it will mark the control block of the associated Logical Unit 32 as not being reserved, thereby indicating that a SCSI RELEASE command has been received from the remote SCSI initiator 33. It can also purge the write queue.

If there is data on the read queue, and an EOF is not the last event on the read queue, then it can purge the read queue. This allows a complete transaction that has been queued for delivery to the application 17a to be transmitted successfully, and an incomplete transaction, i.e. a transaction not properly bracketed with NOOP and WEOF CTC command codes, to be flushed. If there is a read thread waiting for data on the read queue, or a thread waiting to put data on the write queue, it can wake up those thread or threads now. If the event is SCSI_ERROR, it can mark the error. This is an indication of a software or hardware failure detected in the SCSI target driver 23, and that all subsequent read( ) or write( ) system calls for the associated Logical Units will fail with an I/O error, thus notifying the application of an unrecoverable error.

Further, additional disclosure not specifically included in the specification herein, but would be known to one skilled in the art should be considered to be inherently included.

What is claimed is:

1. An apparatus for transferring data in a heterogeneous storage network system comprising:
at least one first device having data stored thereon and having a first protocol;
at least one first data transmission program residing on the at least one first device;
at least one second device having data stored thereon and having a second protocol;
at least one second data transmission program residing on the at least one second device;
a gateway coupled to the at least one first device and the at least one second device; and
a module operatively coupled to the gateway that permits the at least one first data program and the at least one second data program to map addresses of each other to create a data path for transmitting data between the at least one first device and the at least one second device.

2. The apparatus of claim 1, wherein the gateway includes at least one first device emulator that permits the at least one first device to perceive the gateway as at least one other first device.

3. The apparatus of claim 1, wherein the gateway includes at least one second device emulator that permits the at least one second device to perceive the gateway as at least one other second device.

4. The apparatus of claim 1, wherein the at least one first device is a channel-to-channel device capable of issuing commands and responses for data and the at least one second device is a small computer system interface device capable of issuing commands and responses for data.

5. The apparatus of claim 4, wherein the data control module includes a character driver that interfaces with the commands and responses of the channel-to-channel device and the small computer system interface device to facilitate the transfer of data.

6. The apparatus of claim 5, further including a small computer system interface driver operatively coupled to the gateway, wherein the character driver directs the transmission of data from the channel-to-channel device to the small computer system interface driver which transmits it to the small computer system interface device.

7. The apparatus of claim 5, wherein the character driver can load and unload identifier information that permits the identification of either the channel-to-channel device or the small computer system interface device.

8. The apparatus of claim 7, wherein the identifier information can be at least one selected from the group comprising an adapter number, at least one logic unit number, and information related to the type of emulation needed.

9. The apparatus of claim 6, further including at least one read queue and at least one write queue linked together in the gateway to permit the character driver and the small computer system interface driver to exchange data.

10. The apparatus of claim 1, further comprising:
a channel-to-channel processing module in the gateway to open the at least one first data transmission program or the at least one second data transmission program when the at least one second device or the at least one first device respectively requests data.

11. The apparatus of claim 10, further including:
at least one small computer system interface subsystem to interface with the at least one second device;
at least one write queue in the gateway for receiving data; and
at least one read queue in the gateway for transmitting data, wherein the data control module exchanges data with the small computer system interface subsystem through the at least one write queue and the at least one read queue.

12. The apparatus of claim 1, further including at least one logic unit number in the gateway, wherein the data control module and the small computer system interface subsystem exchange data after the channel-to-channel processing module binds to the at least one logic unit.

13. The apparatus of claim 12, wherein data exchanged between the data control module and the small computer system interface subsystem can be read initially from a channel input/output device of the at least one first device and subsequently transmitted to a small computer system interface input/output device of the at least one second device as a result of a READ command.

14. The apparatus of claim 12, wherein data transmitted to the data control module by a small computer system interface input/out device by a small computer system interface WRITE command is written to a channel input/output device upon a channel-to-channel READ command.

15. The apparatus of claim 11, further comprising a FICON channel-to-channel device coupled to the gateway such that the data control module provides the small computer system interface subsystem mapping information that maps a small computer system interface target logic unit number to the FICON channel-to-channel device.

16. The apparatus of claim 15, wherein the identifier information can include a MVS system SMF ID of a MVS LPAR, which controls the at least one first data transmission program.

17. The apparatus of claim 15, wherein the mapping information can include a MVS Device Number that the at least one first data transmission program uses to access the at least one FICON channel-to-channel device.

18. The apparatus of claim 1, further comprising a small computer system interface initiator in operative communication with the at least one second device that transmits identifier information to the at least one second data transmission program that uses the identifier information to verify a connection with the at least one first device.

19. The apparatus of claim 1, wherein data transmitted between the at least one first device and the at least one second device is read and written in blocks that are received and transmitted on at least one Fibre Channel card as packets.

20. The apparatus of claim 1, wherein the at least one first device is a mainframe.

21. The apparatus of claim 1, wherein the at least one second device is a Server.

22. The apparatus of claim 1, wherein the at least one first device is a mainframe connected by FICON connectivity and the at least one second device is a server connected by Fibre Channel connectivity.

23. A method of transferring data in a heterogeneous storage network system, comprising the steps of:
loading at least one first data transmitting program on at least one first device having a first protocol;
loading at least one second data transmitting program on at least one second device having a second protocol;
connecting the at least one first device and the at least one second device to a gateway having a data control module in operative communication therein; and
permitting the at least one first data transmitting program to communicate with the data control module to open a data path in the gateway to the at least one second device, whereby data can be transmitted between the at least one first device and the at least one second device through the data path.

24. The method of claim 23, further including permitting the second data transmitting program to communicate with the data control module to open a data path in the gateway to the at least one first device, whereby data can be transmitted between the at least one second device and the at least one first device through the data path.

25. The method of claim 23, further including a channel-to-channel controller interfacing with a character driver of the data control module to open the at least one first data transmitting program or the at least one second data transmitting program.

26. The method of claim 23, further including:
binding a channel-to-channel controller to at least one logic unit number of the gateway;
queuing at least one block of data by a character driver in the control module on to at least one list stored on the gateway;
opening a data path between the channel-to-channel controller and the character driver;
informing the character driver by the channel-to-channel controller that a channel input/out device associated with a logic unit number in the gateway is online; and
transferring data between the channel input/output device and a small computer system interface input/output device stored in the gateway for communicating with the at least one second device.

27. The method of claim 23, further including:
binding a channel-to-channel controller to at least one logic unit number of the gateway;
queuing at least one block of data by a character driver in the control module to at least one list on the gateway;
opening a data path between the channel-to-channel controller and the character driver;
transmitting data from the at least one second device to the character driver; and
transmitting data from the character driver to a channel input/output device associated with the at least one first device.

28. The method of claim 27, further including disclosing configuration information to a target subsystem in the gateway, which facilitates mapping the logic unit number to a FICON channel-to-channel device associated with the at least one first device.

29. The method of claim 28, further including:
setting a cyclic redundancy check field in a data packet to a predetermined number in the at least one second device;
issuing an at least one second device SCSI write command;
performing a cyclic redundancy check calculation by the gateway;
inserting into the cyclic redundancy check field the cyclic redundancy check calculation;
delivering the data packet to a FICON I/O device in operative communication with the gateway;
removing the cyclic redundancy check field from the data packet;
inserting the cyclic redundancy check field into a channel-to-channel header;
placing a predetermined value in the cyclic redundancy check field in the data packet; and
performing a cyclic redundancy check of the data packet during a channel-to-channel read command by the at least one first device.

30. The method of claim 29, further including detecting an error in the data packet by the at least one first device and issuing an error notice.

31. The method of claim 29, further including transmitting the data packet to the at least one first data transmission program on the at least one first device if no error is detected.

32. The method of claim 28, further including:
placing a predetermined value in a setting a cyclic redundancy check field on a data packet;
issuing an at least one second device channel-to-channel write command;
performing a cyclic redundancy check calculation by the at least one first device;
inserting into the cyclic redundancy check field the cyclic redundancy check calculation;
inserting the cyclic redundancy check field calculation into a channel-to-channel header;
sending the data packet to the gateway;
moving the cyclic redundancy check field from the channel-to-channel header and placing it into the data packet;
placing the cyclic redundancy check and data packet in a write queue;
sending a SCSI read command to a SCSI target subsystem of the gateway that stores the cyclic redundancy check data field in a transient variable;
placing a predetermined value into the cyclic redundancy check field of the data packet;
calculating a cyclic redundancy check on data packet; and
comparing the calculated cyclic redundancy check value and the cyclic redundancy check value stored in the transient variable.

33. The method of claim 32, further including completing the SCSI read command if the calculated cyclic redundancy check value matches the cyclic redundancy check stored in the transient variable, thereby indicating there is no error in the data transmission.

34. The method of claim 32, further including completing the SCSI read command and issuing an error when the calculated cyclic redundancy check value does not match the cyclic redundancy check stored in the transient, thereby indicating an error in the data transmission.

35. A system for transferring data in a heterogeneous storage network system, comprising:
a first data transmitting means disposed on at least one first device having a first protocol for transmitting and receiving data;
a second data transmitting means disposed on at least one second device having a second protocol for transmitting and receiving data;
a connecting means for connecting the at least one first device and the at least one second device, wherein the connecting means includes at least one data control means for controlling the transmission of data therethrough; and
communication means for permitting the first data transmitting means to communicate with the at least one data control means to open a data path in the connecting means to the at least one second device, whereby data can be transmitted between the at least one first device and the at least one second device through the data path.

36. The system of claim 35, further including a second data transmitting means for communicating with the at least one data control means to open a data path in the connecting means to the at least one first device, whereby data can be transmitted between the at least one second device to the at least one first device through the data path.

37. The system of claim 35, further including a means for opening the at least one first data transmitting means or the at least one second data transmitting means for transmitting data there between.

38. The system of claim 35, further including:
means for binding a channel-to-channel device to at least one logic unit number of the connecting means;
means for queuing at least one block of data by the control means to at least one list on the connecting means;
means for opening a data path between the channel-to-channel device and the at least one data control means;
means for informing the at least one data control means by the channel-to-channel device that a channel input/out device associated with the logic unit number is online; and
means for transferring data between the channel input/output device and a small computer system interface input/output device in operative communication with the connecting means.

39. The system of claim 35, further including:
means for binding a channel-to-channel device to at least one logic unit number of the connecting means;
means for queuing at least one block of data by the at least one control means to at least one list on the connecting means;
means for opening a data path between the channel-to-channel device and the control means;
means for transmitting data from the at least one second device to the at least one data control means; and
means for transmitting data from the control means to a channel input/output device associated with the at least one first device.

40. The system of claim 35, further including an initiating means operatively coupled to the at least one second device to initiate transmission of the data by communicating with the at least one data control means.

41. The system of claim 40, further including error issuing means for issuing an error if the initiating means does not reserve a logical unit number in the connection means.

42. The system of claim 35, further including error issuing means for issuing an error when a SCSI read or write command is issued from the at least one second device when the data control means is offline.
